(19) United States
(12) Patent Application Publication
(10) Pub. No.: US 2008/0114841 A1
(43) Pub. Date: May 15, 2008

(54) SYSTEM AND METHOD FOR INTERFACING WITH EVENT MANAGEMENT SOFTWARE

(76) Inventor: Daniel T. Lambert, Orem, UT (US)

Correspondence Address: THORPE NORTH & WESTERN, LLP., P.O. Box 1219, SANDY, UT, 84091-1219, US

(21) Appl. No.: 11/559,806

(22) Filed: Nov. 14, 2006

(51) Int. Cl. G06F 15/16; G06Q 30/00; G06F 9/44

(52) U.S. Cl. 709/206; 719/318; 705/14

(57) ABSTRACT

A system and method are provided for interfacing with event management software. The method includes the operation of sending a text message from a wireless user device to a conversion module. The text message can be converted into an event record using the conversion module. A further operation is creating event entries in the event management software based on the event record obtained for the event management software from the conversion module.

### FIELD OF THE INVENTION

The present invention relates generally to electronic communication.

### BACKGROUND

Electronic scheduling and time tracking software applications have become a valuable part of many individuals' and organizations' work flow and time management. Scheduling meetings or events with others in a group may be convenient using a networked scheduling tool such as Microsoft Outlook®, Novell Groupwise®, and others. These electronic scheduling tools allow a meeting planner to identify time periods when the desired participants of a meeting may or may not be available. Users can also schedule their own personal appointments by accessing the calendaring client, and the user can enter appointments directly into the calendar.

Users of electronic calendaring and time management tools can also create calendar items in a personal digital assistant (PDA). Then the personal digital assistant can be linked to the main calendaring application through a hardware cradle device. This allows a user to synchronize the calendaring data with the main calendaring application and database.

In a similar way, time goals can be tracked in project development applications that map out expected time milestones for projects. Project development applications also help divide large projects into smaller project units for tracking purposes. This helps groups manage whether they are meeting their time goals for projects in a detailed way.

Not only can project milestones be managed using time management applications but the time spent to meet those goals can be tracked in timekeeping software. Users can enter the time spent on projects into a software application. Frequently, the amounts of time are converted to monetary amounts that may be charged to an entity paying for the project.

Current electronic calendaring, time management, and event control systems often require the purchase of additional software and equipment to provide expanded event management functionality or the remote access capabilities of these application are limited. Making real-time changes to an event management application from a remote device often requires a high speed Internet connection that can access the calendaring database through a complex web application interface. In some situations, effective web interfaces for these event management applications do not even exist.

### SUMMARY

A system and method are provided for interfacing with event management software. The method includes the operation of sending a text message from a wireless user device to a conversion module. The text message can be converted into an event record using the conversion module. A further operation is creating event entries in the event management software based on the event record obtained for the event management software from the conversion module.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram illustrating an overview of a system and method for interfacing with and controlling event management software in accordance with an embodiment of the present invention;

FIG. 2 is a block diagram illustrating a detailed embodiment of a system for interfacing with and controlling event management software using a sending and receiving client and a message conversion module;

FIG. 3 is a block diagram illustrating a more detailed embodiment of a system for interfacing with and controlling event management software; and

FIG. 4 is a flow chart illustrating an embodiment of a method for interfacing with and controlling event management software.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

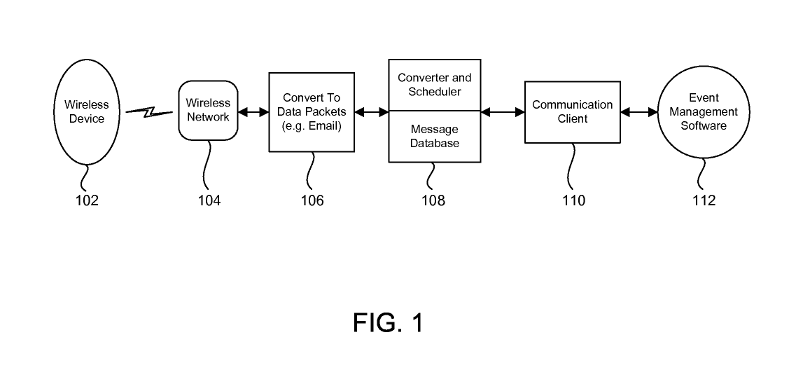

FIG. 1 illustrates a method and related system components for interfacing with and controlling event management software on a computing device. A text message can be sent from a wireless user device 102 to a wireless network 104 maintained by a wireless service provider. Examples of current wireless service providers include Verizon, Sprint, T-Mobile and others. The text message is then sent to a conversion device 106 that can convert the text message to data packets or email messages. The conversion device may be controlled by a wireless service provider, a third party or an Internet based text messaging service provider. Text messages sent to a telephone number can also be converted through a data switch that may be owned by someone other than the wireless service provider. The wireless user device may be a cell phone, a Blackberry device, a wireless personal digital assistant, wireless 2-way pagers, portable instant messaging devices, a wireless laptop, or other similar wireless computing devices.

The data packets or email messages can be sent to a conversion module 108 that is able to convert the text message into an event record. The conversion module may store the event records in a message database. Alternatively, the event records can be stored temporarily for communicating to other networked devices but storing the event records in a database is not required if no history of the messages is going to be kept.

Event records can be obtained or retrieved from the conversion module for the event management software. The retrieval may be performed by an independent communication client 110. Alternatively, the retrieval of the event records can be performed by an integrated process associated with the event management software, which is always active to send and receive communications. For example, the event management software may have a client program that is loaded when an operating system starts up. The communication client can instruct the event management software to create event entries in the event management software based on the event records received.

For example, a user may send a text message that is intended to create an event entry in the event management software. The user can send a text message to an email address or telephone number with a timekeeping entry or a calendar entry. In the case of a calendar, the calendar entry can be placed on the user's viewable calendar based on the original text message that is sent.

The event management software can also send a text message regarding the event record back to the wireless user device via the conversion module. The end user can setup the system to send a text message reminder to the user at a defined time interval before the actual event occurs. In addition, the event management software and/or communication client can send records or messages back to the conversion module and server even when a text message or event in the event management software is not linked to the message.

For instance, a user may set the event management software and communication client to send a text message to the user five minutes before any selected type of event occurs. Another example is the ability for the event management software to send a reminder text message back to the wireless user device via the conversion module regarding a status of a hardware device. This way the status of items such as a light, a stove, or house temperature can be determined and sent via text message. In addition, the status of events that have previously occurred, such as a timecard event, or a hardware device, can be monitored.

The present system and method can also add or attach a separate message to the text message using the conversion module. The message that is added may be an advertisement with the text message that is configured to be viewable by users. Customized advertising can be generated by enabling the conversion module to select advertising based on key words identified within the text message. The messages will generally be added to outgoing messages from the event management software. There may also be cases where the messages will be added on an in-going basis. Workflow reminders may also be added to in-going messages. For example, a timekeeping entry that does not include any time may have an added reminder to encourage the user to add time at later point.

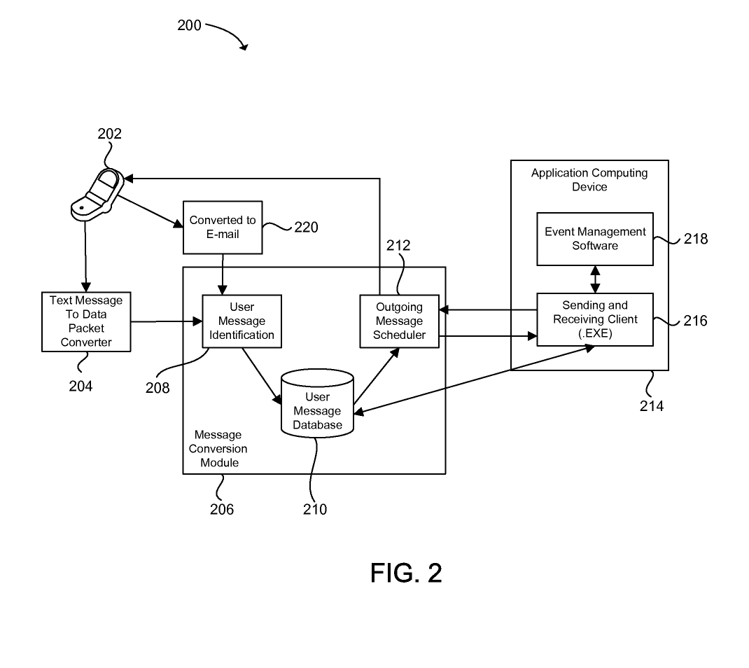

Referring now to FIG. 2, a system for controlling and communicating with event management software on a computing device is provided. A wireless user device 202 can send a text message to provide instructions to and control the event management software 218. The text message can be sent to either a phone number or an email address. If the text message is sent to a phone number the text message can be converted to data packets by a text message to data packet converter 204. The data packets may include the text data in a raw form or in the form of an email message that is sent to the user's account. Another type of formatting besides email formatting may be used for the data packets such as XML, comma delimited format or another useful data format. If the user sends the text message to an email address, the wireless service provider can convert the text message to an email message 220 which is sent across the Internet to the email destination.

The user's data packets or email containing the text message are then transmitted to a message conversion module 206. The message conversion module can use the user message identification module 208 to determine which user's account the message should be directed to. The routing of the data packets can be performed based on the user's unique account that has been created on the message conversion module or server.

Each user may receive their own unique e-mail account, or a joint e-mail account, and a wireless phone number or device ID can be used for verification purposes. A source ID can come from the phone number embedded in the message. In the case where the program determines that the incoming number or source ID is different than the expected number for the account, then the message conversion module can request an account password. This allows users to send in messages from another person's cell phone or other remote device by using the appropriate account name and password. In this way, the cell phone number can be a unique wireless key. An account number and password combination can be a different unique key too.

Alternatively, the user's account can be identified based on a phone number, electronic address, unique email address, or the MAC address (Media Access Control) extracted from the wireless device. The data packets containing the text message from the wireless user device are received and can then be converted to event records by the conversion module 206.

A central database or user message database 210 can be configured to store the event records after the text messages are converted. An outgoing message scheduler 212 can be in communication with the central database to schedule the communication of the event records to requesting devices. The outgoing message scheduler can also schedule the transfer of event records by the sending and receiving client 216 and schedule delivery of return messages to the wireless user device 202. The sending and receiving client can be a stand alone executable in one embodiment.

The outgoing message scheduler 212 can also send out system messages or other messages that are not related to the text messaging of the overall system. For example, the outgoing message scheduler can send out system maintenance notices, error messages and other items that are not initiated by a text message. There are also events that can be created through a web interface that can be entered into the central database. The data for these events and scheduled items can be sent to event management software without using the outgoing message scheduler.

A sending and receiving client 216 or scripting client can be located on a local computer where the event management software resides. The local computer 214 (or application computing device) may be a personal desktop computer, a personal digital assistant (PDA), and any other computing device with enough computing power to run the event management software 218. The sending and receiving client can retrieve an event record from the central database via the outgoing message scheduler 212. Then the sending and receiving client can request the creation of event entries in the event management software based on the event record. In response, the desired event entries will be generated in the event management software and the end user will be able to view event entries that were sent using a text message. In some situations, the sending and receiving client may directly communicate with the user message database 210 and bypass the outgoing message scheduler.

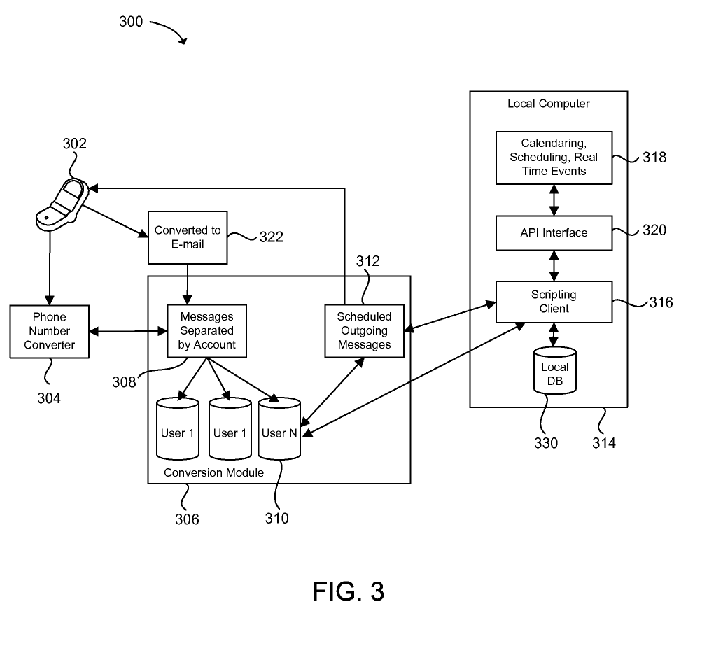

FIG. 3 illustrates a more detailed embodiment of a system and method for event management software that can be interfaced with using any cell phone 302 or Blackberry type device that has text messaging capability. By sending text messages to a central server, users can control their remote access event management software by using any cell phone capable of sending the text messages. Event management software 318 can be software such as an electronic calendar, a project management application, an application that controls electronic devices, and a time logging application.

The same cell phone can then be used to receive text message reminders of when events are occurring. The data sent back and forth can also be viewed, modified, and controlled through a separate web interface or existing office product. Examples of existing calendaring viewers include Thunderbird, Microsoft Outlook, and desktop project management software. The event management application can even be home automation and scheduling software. The web interfaces or stand alone clients are optional though. The ability to make modifications to the calendar or similar software applications can be performed using text messages alone, if desired. The calendar, for example, might be operable without any user interface.

The system functions are orchestrated through a series of data conversions. A user sends a text message from a cell phone 302 to either an e-mail address 322 or a dedicated phone number 304. In either case, the message is converted from text message format (e.g., SMS) to e-mail format or another data packet format. This conversion may be provided by a wireless service provider who converts the text message to an email 322, and in some cases an external party that is paid to make the conversion 304.

In both cases, the data is delivered to individual or shared e-mail accounts 308 on a custom programmed web server or conversion module 306. There may be an e-mail account established on the web server for each user. However, users may have shared accounts also. The accounts are configured to specifically accept data from the user's cell phone and eliminate incoming spam. If a user sends a text message through the system and does not have an account, an account can automatically be created for the user. The conversion module software can also parse the e-mails or data packets as they are received or on a timed batch basis.

The web server for the conversion module can convert the data packets into event records. Then the software can populate or update the server database(s) 310 with the information or event records. The database(s) can be in any format including MySQL, Access, Microsoft SQL, Oracle, or any other available database system. The parsing and converting of the incoming data packets or emails to event records may be performed with PHP, ASP, Cold Fusion, or any other web language. The central database(s) 310 can also record all scheduled outgoing text messages. A script can run periodically to send out reminder text messages from the database through the scheduled outgoing messages module 312.

In order for a desktop-based event management application or other application software to receive and send text message events, a scripting client 316 or desktop process may continually run in the background of the client's local computer 304. Once the scripting client application has been installed, the application can be configured to start running in the background upon each subsequent startup of the computer. While running, the scripting client can send a request to the web server for new data for every time period (e.g., every minute, five minutes or 15 minutes). This scripting client that is constantly running is able to provide an active communication channel for the text messaging commands. In addition, the scripting application is able to provide a connection through firewalls and other types of security mechanisms because the scripting client application is an executable that initiates the communications with the conversion module and its accompanying web server.

In one embodiment, a client that runs using the Macromedia Flash environment can be provided. This process is sometimes referred to as “flash remoting” and may use the Flash scripting language to retrieve the data from the conversion module. By packaging the scripting code as an executable, the software can have the advantages of a desktop application and the ability to interact with a web server without any security or communication barriers. This link from desktop applications to web server can be created with nearly any programming language, though, and is not restricted to Flash scripting. Other examples of programming environments that can be used are Java, C++, ActiveX, or other executable program environments.

As the program on the user's desktop receives the event records, the records can be stored in a local database 330 (MySQL, MSSQL, or Access). At this point, the text message is stored on the web server 310 and also on the user's local computer 314 in the local database. This local database provides offline access to the event information when a network connection is not available. The scripting client can identify new data records in the user's event management software database since the last synchronization and upload the identified data to the web server. When all of the data has been exchanged, the web database 310 and local database 330 are considered to be synchronized.

In another embodiment, event records may not be written to a local database. Instead, the event records can be written directly to the proprietary databases, binary files, or XML files controlled by the event management software itself. This can avoid using the local database and any computing or cost overhead associated with the local database. However, using the event management software's storage systems may not allow offline operations to occur as readily.

Once such handshakes are completed, the scripting client (e.g., background application which may be created using Visual Basic, Java, or C++) can take the data from the local database and integrate the information into the event management software. An API interface 320 can communicate with the event management software to provide the event management software 318 with instructions for generating the events. Examples of desktop applications that can receive the data include email and calendaring systems (e.g., Outlook, Thunderbird), project management software, or home automation systems. Since each different desktop application requires data in a slightly different format, an API interface created using an intermediary language such as Visual Basic is used to reformat the data from the raw data to a format usable by the event management applications 318.

The user can have the choice to view their data in the event management software with a Flash based script interface, a web based interface, or a desktop application chosen by the user. At any point in the process, the user can view the data on the web server directly by way of a website login. In other words, the user may not need access to any separate software or a specific local machine in order to manipulate or view the time oriented or scheduled tasks and events. The events can be viewed in a web application or in raw text listings. The software plug-ins for local desktop applications are simply additional features available to customers.

If a user's text message command requires immediate feedback, then the system can generate an outgoing text message independent of the reminder text message database. The response reminder messages may be sent out as e-mails or as text messages. The individual cell phone companies convert these response e-mails to SMS text messages which are then sent to individual end users. E-mail to SMS conversion by the cell phone company allows the present system to send reminders without incurring system overhead or costs.

The actual syntax of text messages to control the event management application can use a variety of formats. A user might schedule an appointment on March 3 by sending in a text message that says “9-10 AM Mar 3” or “Mar 3 9 AM Meeting.” Regular expressions and detailed software methods can be used to search for certain phrases which are used extensively by the conversion server to try to interpret the message. If the user does not enter the data correctly, the server may make several attempts to change the data into a usable format. If the server cannot accurately interpret the message, the user receives a text message notification of the error and a request to resend the message.

The regular expressions are programmed to handle many levels of customization beyond the simple scheduling of events. A user can specify a reminder interval by writing “T-15,” meaning that the user will receive a reminder 15 minutes prior to the event. Any data field in Microsoft Outlook, calendaring software, or other event management software may be controlled by the custom text messages.

The customization and control over the event management software can go beyond a calendaring event in a calendaring application. A user might want to add an item to a general to-do list on the calendar desktop. The text message from the wireless device may be written “To-Do Plan a meeting.” “Plan a meeting” would then display in the user's respective software program in the appropriate category.

The customization of text messages can also be used to interface with other established desktop products, such as software that controls devices in a house. By interfacing with the systems and calendars involved in home automation, text messages can be used to turn a light on or off, or schedule the stove to turn on at a certain time. The command “Light 1 Off 9 AM Mar 3” may turn off the first light in the house on the specified day. An example of a program that the present software can interface with is ActiveHome Pro Home Automation Software™ from the X10 corporation. The text message can be converted by the present system and then the commands can be used to manipulate the desktop software that controls devices in a home. The use of desktop control software in conjunction with a remote text messaging device poses a significant cost advantage over traditional home automation methods. This present system and method eliminates the need for an extensive house wide phone activated system. Text messages can be used to instruct the desktop application to broadcast the automation signals.

The event management application can also provide connections to wireless devices that are driven by what is entered in the event records. For example, the event management application may be a home automation application that can communicate with wireless devices that the application controls.

Users can be provided with the ability for the user to check their calendar, to-do list, or status of devices from the cell phone or other wireless devices. This status checking may be activated by an issued command such as “Check To-Do,” or “Check March 3.” Once the server parses the check command, the web server will search the server databases and form a string of existing events or a list of currently active devices. This listing is then converted to an e-mail or data packet which is forwarded to cell phone companies or third parties for distribution. The user can receive one or more text messages detailing the events for that day, the details of a to-do list, or the devices that are currently on. At any time, the user may have the option to modify, delete, or append data to the existing event using text message transactions.

Users are accustomed to viewing electronic schedulers in a graphical form. The text message system described above is meant to supplement existing software, not replace the graphical interfaces to which customers are accustomed. The data from the web server can be integrated in an automatic fashion into a user's existing software system, whether on the desktop or on a website. The converted text message data is adaptable to a user's current calendaring interface, such as Outlook and Thunderbird, or home automation system.

Another component of the system and method is the ability to attach advertising to each text reminder that is sent to a user. Assuming that the customer has not paid for an ads-free service, each outgoing reminder message may have customized advertising attached.

One of the advantages to users is that these operations are completed without using “Exchange Server” software or a messaging and collaboration server with its accompanying database. Exchange servers require specific operating systems and software and are used to coordinate e-mail and calendaring functions. By using the present system and software, users and businesses can work independently of exchange servers, or use the software system in conjunction with the exchange process and server.

In the present system and method, it is important to have data security. Accordingly, users have the option of adding passwords to their accounts. This is particularly valuable for home automation systems. For a text message to be processed, the user will need to send in the password, if the user has already turned on the security features. All server transactions may be protected with hashing algorithms, preventing people from unauthorized access. Of course, other types of encryption and security mechanisms can be used to protect the data. The software system can also include built-in quantity regulations that will send out alerts if too many text messages are being processed. High strength spam filters can also be applied to the e-mail accounts.

In another embodiment of the system, the messaging can be used in conjunction with a timekeeping system that enables users to clock in/clock out of the system. This can enable employees to clock in using a text message “Clock in Now” or “Clock in 8 AM.” Management can force clock-ins to be issued only at the current date or time, or they can allow the employee to make modifications to the overall time card. The time stamp of the text message origination is checked and the punch in or punch out is then recorded in the database. The system may even check the location of the user and enter such information in the database, if the hardware is available in the wireless user device to confirm the physical location of the user.

The data can then be used to interface with any existing payroll/employee tracking system, such as Kronos or Timeforce. The punches using a text message are meant to supplement existing time monitoring systems, but can also be integrated into a standalone program with a web interface, desktop interface, or cell phone interface. Since the software can interface with desktop products, these time punches might also interface with desktop accounting software, Microsoft Excel, or other desktop applications that deal with issuing payments.

Revenue can be generated by the ability to append formatted advertising to text message reminders. So, if a user has a meeting with the accountant at three PM on March 3, they may receive a message similar to the following:

3 PM Meeting with Accountant.

Ad: Free Accounting Services

www.accting.com.

The present software does not actually read text messages, but the software can find and generate pertinent advertising for text messages based on keywords in the messages. This provides direct customized advertising on wireless devices (e.g., cell phone) or with scheduled events that are setup from a wireless device. This method has significant advantages over traditional e-mail marketing. For one, the software can customize marketing to the user's message. Second, the advertisements included with the text messages have less chance of being restricted by spam blocking, pop-up blockers or filters.

Another benefit of the revenue model described is that the system and software will have the user's permission to send attached advertisements. This is because the user will not have access to any of the services or products described herein unless the user either pays for an “ad-free” service or submits to the user agreement which requires the advertisements to be attached to the text messages. The user agreement can state that the user agrees to receive marketing attached to reminders, but that there will be no additional fee from the cell phone company or the system and software being used. The free model incurs no additional cost to the user because 1) the software and services can be used at no cost to the users; and 2) the user will have already paid the cell phone company for the text message reminder.

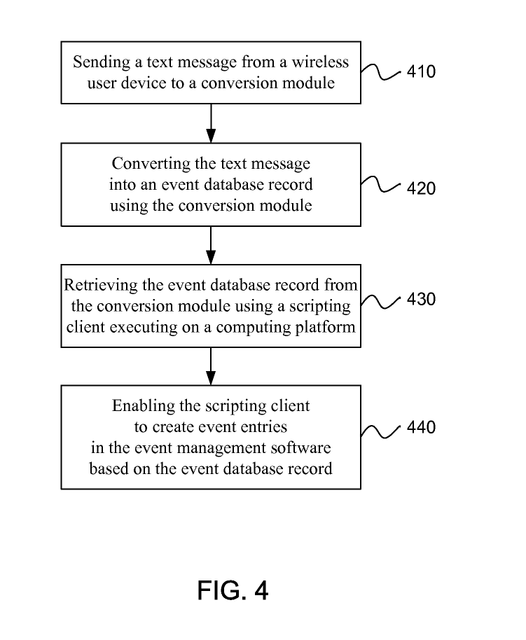

FIG. 4 illustrates a method for controlling event management software. The method can include the operation of sending a text message from a wireless user device to a conversion module, as in block 410. The text message can be converted into an event record using the conversion module, as in block 420. An intermediate step may be converting the text messages into data packets or emails before they are converted into event records.

The event record can be retrieved from the conversion module using a scripting client, as in block 430. The scripting client is an executable process that is active on a local computing platform along with the event management software. In other words, both the scripting client and the event management software are generally located on the same hardware device together, but this is not required. This allows the scripting client to control the event management software by making requests via the APIs of the event management software. The API interface can be configured to manage requests to and messages from the event management software related to events in the event management software.

The scripting client is able to create event entries in the event management software based on the event record, as in block 440. As a result, the text messages sent by the wireless device are used to create event entries in the event management software. The event entries may be calendar events, reminder events, deadline events, time tracking events, real-time automation events, real-time device automation events, and scheduled device automation events.

As the event records are processed, the records can be stored in a centralized database in the server and in a local database on the local computer. The centralized database can be synchronized with the local client database. The synchronization of the local client database with data from the centralized database can be performed using the scripting client.

The system and method allows users to control their calendar, to do-list, project management software, and household devices from anywhere in the world with cell phone coverage. The text messages are processed in real time instead of having delayed synchronization, which can make workplaces more efficient. Beyond the practicality of the product, the business model allows virtually anyone with a cell phone and text messaging ability to take advantage the present invention.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for interfacing with event management software, comprising:
sending a text message from a wireless user device to a conversion module;
converting the text message into an event record using the conversion module;
retrieving the event record from the conversion module using a scripting client executing on a computing platform with the event management software; and
enabling the scripting client to create event entries in the event management software based on the event record.

2. A method as in claim 1, further comprising the step of storing the event record in a centralized database.

3. A method as in claim 1, wherein the event management software is selected from the group consisting of: an electronic calendar, a project management application, an application that controls electronic devices, and a time logging application.

4. A method as in claim 1, further comprising the step of using a web server as the conversion module that can receive data packets from the wireless user device, wherein the web server is configured to convert the data packets into event records.

5. A method as in claim 1, wherein the step of sending a text message further comprises the step of sending an SMS text message or an email message.

6. A method as in claim 1, wherein the step of sending a text message from a wireless user device further comprises the step of sending a text message from a wireless user device that is selected from the group consisting of a cell phone, a Blackberry device, a wireless personal digital assistant, wireless 2-way pagers, portable instant messaging devices, and a wireless laptop.

7. A method as in claim 2, further comprising the step of synchronizing the centralized database with a client database and synchronizing the client database with updated data from the centralized database using a sending and receiving client.

8. A method as in claim 1, wherein the event entries are selected from the group consisting of: calendar events, reminder events, deadline events, time tracking events, real-time automation events, real-time device automation events, and scheduled device automation events.

9. A system for controlling event management software on a computing device, comprising:
a message conversion module configured to receive data packets containing a text message from a wireless user device and to convert data packets to event records;
a central database configured to store the event records after the text messages are converted; and
a scripting client configured to obtain an event record from the central database, wherein the scripting client is configured to create event entries in the event management software based on the event record.

10. A system as in claim 9, further comprising an outgoing message scheduler in the message conversion module, the outgoing message scheduler being configured to schedule the transfer of event records by the scripting client and to schedule delivery of messages to the wireless user device.

11. A system as in claim 9, further comprising a text message to data packet converter configured to receive text sent to a central phone number and to convert the text messages to data packets or emails that are forwarded to the message conversion module.

12. A system as in claim 9, further comprising an API interface for the event management software, the API interface being configured to manage requests to and from the event management software related to events in the event management software that correspond to the event record.

13. A system as in claim 9, further comprising a message separation module for the message conversion module, the message separation module being configured to receive emails or data packets for a user and to identify a sender of the email or data packet based on a unique wireless key.

14. A system as in claim 13, wherein the unique wireless key selected from the group consisting of: a cell phone number, password and account information, and a MAC address.

15. A system as in claim 9, wherein the message conversion module is configured to add a separate message to the text message.

16. A system as in claim 9, wherein the message conversion module is configured to add an advertisement to the text message.

17. A method for interfacing with event management software on a computing device, comprising:
sending a text message from a wireless user device to a conversion module;
converting the text message into an event record using the conversion module; and
creating event entries in the event management software based on the event record that is obtained for the event management software from the conversion module.

18. A method as in claim 17, further comprising the step of enabling the event management software to send a text message regarding the event record back to the wireless user device via the conversion module.

19. A method as in claim 18, further comprising the step of attaching a separate message to the text message using the conversion module.

20. A method as in claim 18, further comprising the step of including an advertisement with the text message.

21. A method as in claim 20, further comprising the step of selected customized advertising by enabling the conversion module to customize advertising based on key words identified within the text message.

22. A method as in claim 18, further comprising the step of enabling the event management software to send a reminder text message back to the wireless user device via the conversion module regarding the upcoming occurrence of an event represented by the event record.

23. A method as in claim 18, further comprising the step of enabling the event management software to send a reminder text message back to the wireless user device via the conversion module regarding a status of a hardware device.

24. A method for providing a text message interface for event management software, comprising:
generating a message related to an event entry in the event management software;
sending the message to a conversion module;
converting the message to a text message using the conversion module; and
sending the text message from the conversion module to a wireless user device.

25. A method as in claim 24, comprising the step of sending a message related to event entries that is a reminder for the event entry.
